(19) United States
(12) Patent Application Publication
(10) Pub. No.: US 2014/0112175 A1
(43) Pub. Date: Apr. 24, 2014

(54) Methods of Operating a Wireless Device, and Apparatus and Computer Programs Therefor

(71) Applicant: RENESAS MOBILE CORPORATION, Tokyo (JP)

(72) Inventors: Anna PANTELIDOU, Oulu (FI); Timo Kalevi KOSKELA, Oulu (FI); Juho Mikko Oskari PIRSKANEN, Kangasala (FI); Sami-Jukka HAKOLA, Kempele (FI)

(73) Assignee: RENESAS MOBILE CORPORATION, Tokyo (JP)

(21) Appl. No.: 14/059,507

(22) Filed: Oct. 22, 2013

(30) Foreign Application Priority Data
Oct. 23, 2012 (GB) 1219040.1

(51) Int. Cl. H04L 5/00

(52) U.S. Cl. CPC H04L 5/0073
USPC 370/252; 370/329

(57) ABSTRACT

Embodiments of the present disclosure solve problems of throughput reduction due to collisions, busy medium, and deferred transmission due to overlapping wireless networks (e.g. 802.11 OBSS) by allowing devices suffering from overlapping interference to have sufficient chances to transmit and/or receive successfully. Embodiments include methods for a first device (e.g. 802.11 AP) to communicate data via a medium shared with other devices (e.g. 802.11 APs and/or STAs) located in an overlapping service area but not under common control with the first device. Embodiments also include methods for a first device (e.g. 802.11 AP) to negotiate reservation of a shared medium requested by a second device (e.g. 802.11 AP), the two devices being in overlapping service areas but not under common control. Embodiments include wireless communication devices (e.g. 802.11 APs) and computer programs or computer-readable media embodying one or more of the methods.

### CROSS REFERENCE TO RELATED APPLICATION

This application claims the benefit under 35 U.S.C. §119 and 37 CFR §1.55 to UK patent application no. 1219040.1, filed on Oct. 23, 2012, the entire content of which is incorporated herein by reference.

### TECHNICAL FIELD

The present invention relates to apparatus comprising a processing system for a wireless device, methods of operating a wireless device, and computer programs therefor. The disclosure herein relates generally to the field of wireless local-area communications, and particular embodiments relate to methods for improving the efficiency and reliability of data communication within proximate networks of wireless devices that share the same frequency resource but are not under common control.

### BACKGROUND

The 802 LAN/MAN Standards Committee of the Institute of Electrical and Electronic Engineers (IEEE) develops and maintains networking standards and recommends practices for local, metropolitan, and other area networks. The IEEE 802 Standards Committee comprises a number of working groups (WGs), each focussed on developing standards related to a particular area of networking IEEE 802.11 is the working group dedicated to developing standards for wireless local-area networks (WLANs).

Generally speaking, the output of IEEE 802.11 comprises a collection of standards specifying the physical (PHY) and medium access control (MAC) layers for wireless, local-area network operation in unlicensed frequency bands including, for example, around 2.4, 3.6, and 5 GHz. IEEE 802.11 standards are published as official versions along with interim amendments, which are incorporated into subsequent official releases. For example, version IEEE 802.11-2007 incorporated IEEE 802.11-1999 plus amendments 802.11a (OFDM PHY at 5 GHz), 802.11b (higher-speed PHY at 2.4 GHz), 802.11e (quality-of-service), 802.11g (OFDM PHY at 2.4 GHz), 802.11h (spectrum and transmit power management), 802.11i (security mechanisms), and 802.11j (Japan-specific operation). In addition, version IEEE 802.11-2012 incorporated IEEE 802.11-2007 and amendments such as 802.11k (radio resource management), 802.11r (fast secure handoffs), 802.11y (3.6-GHz operation), 802.11n (increased throughput using MIMO and frame aggregation), 802.11p (vehicular operation), 802.11v (network management), and other amendments. Typically, an amendment is developed as a project by a task group (TG) that is dedicated to the particular subject area. One of the current projects, known as 802.11ah, is a PHY amendment that relates to extension of IEEE 802.11 for operation at frequencies below 1 GHz. One of the use cases of 802.11 ah targets applications such as sensor networks, smart metering, healthcare, surveillance, intelligent transport systems (ITS), etc.

FIG. 1A is a block diagram showing the most fundamental architecture of an 802.11 network. The addressable unit in an IEEE 802.11 network is referred to as a station (STA), while the basic service set (BSS) is the basic building block. FIG. 1 shows two BSSs, BSS1 and BSS2, each of which comprises two member STAs, STA1 and STA2 in BSS1, STA3 and STA4 in BSS2. Generally speaking, a BSS is a coverage area and member STAs may communicate directly with each other so long as they remain within it. Because the topology of FIG. 1A is often formed without pre-planning, and retained for only as long as needed by the member STAs, this type of operation is often referred to as an ad hoc network, and each of the BSSs is referred to as an independent BSS (IBSS).

FIG. 1B is a block diagram showing a more complex 802.11 topology in which BSS1 and BSS2 of FIG. 1A are connected into an extended network by a distribution system (DS) comprising a distribution system medium (DSM). The DS enables STAs to be mobile between multiple BSSs by providing the logical services necessary to handle address to destination mapping and seamless BSS integration. STAs access the DS over the wireless medium via an access point (AP), which is an entity that has STA functionality (e.g. it is addressable) and provides access to the DS. Instead of communicating directly with each other as in FIG. 1A, the STAs in FIG. 1B communicate with each other via the AP of the BSS with which they are associated. Accordingly, the BSS topology of FIG. 1B is commonly referred to as infrastructure BSS.

The basic medium access protocol of the 802.11 MAC layer is a distributed coordination function (DCF) that allows STAs with compatible PHY layers to automatically share the wireless channel using carrier sense multiple access/collision avoidance (CSMA/CA) techniques with a random back-off time following a busy medium condition. The CSMA/CA protocol is designed to reduce the collision probability between multiple STAs accessing a medium, at the time when collisions are most likely to occur, i.e. just after the medium becomes idle following a busy medium, since multiple STAs may have been waiting for the medium to become available again. The random backoff procedure, which causes STAs to randomly delay their medium access attempts, helps to reduce such conflicts. The state of the medium is indicated by the carrier sense (CS) function of the 802.11 MAC layer. The CS function distributes reservation information announcing the impending use of the medium, such as by STAs exchanging clear-to-send/request-to-send (CTS/RTS) prior to exchanging data frames, or by various other means specified in the 802.11 standard and amendments.

### SUMMARY

In a first exemplary embodiment of the invention, there is apparatus for a wireless communication device, the apparatus comprising:

at least one processor;

and at least one memory including computer program code;

the at least one memory and the computer program code being configured to,

with the at least one processor, cause the wireless communication device to:

determine the existence of an interference condition in an overlapping service area;

determine a set of devices related to the interference condition;

send a request to reserve the shared medium in the overlapping service area, wherein the reservation request comprises information identifying at least one of the determined set of devices and a first parameter characterising the requested reservation;

receive an acknowledgement from at least one of the devices identified in the reservation request, the acknowledgement comprising an acknowledgement type identifier and a second parameter characterising the requested reservation; and

schedule data communication via the shared medium based on the acknowledgement type identifier and at least one of the first parameter and the second parameter.

In a second exemplary embodiment of the invention, there is apparatus for a wireless communication device, the apparatus comprising:

at least one processor;

and at least one memory including computer program code;

the at least one memory and the computer program code being configured to, with the at least one processor, cause the wireless communication device to:

receive a request to reserve a shared medium in an overlapping service area, wherein the reservation request comprises information identifying at least one address related to the wireless communication device and a first parameter characterising the requested reservation;

determine an acknowledgement type identifier based on at least the first parameter;

schedule data communication via the shared medium based on the information identifying at least one address related to the wireless communication device; and

send an acknowledgement of the reservation request comprising the acknowledgement type identifier and a second parameter characterising the requested reservation.

In a third exemplary embodiment of the invention, there is provided a method for determining the existence of an interference condition in an overlapping service area of a plurality of wireless networks, the method comprising:

receiving one or more signals transmitted by access points in a shared medium of the overlapping service area;

determining a first set of identifiers of wireless networks in the overlapping service area based on information comprising the one or more signals transmitted by the access points;

receiving one or more signals transmitted by stations in the shared medium;

determining a second set of identifiers of wireless networks in the overlapping service area based on information comprising the one or more signals transmitted by the stations; and

determining the existence of the interference condition by comparing the first and second sets of identifiers.

There may also be provided a method for a wireless communication device to communicate data via a medium shared with one or more other wireless communication devices not under common control with the wireless communication device, the method comprising:

determining the existence of an interference condition in an overlapping service area;

determining a set of devices related to the interference condition;

sending a request to reserve the shared medium in the overlapping service area, wherein the reservation request comprises information identifying at least one of the determined set of devices and a first parameter characterising the requested reservation;

receiving an acknowledgement from at least one of the devices identified in the reservation request, the acknowledgement comprising an acknowledgement type identifier and a second parameter characterising the requested reservation; and

scheduling data communication via the shared medium based on the acknowledgement type identifier and at least one of the first parameter and the second parameter.

There may also be provided a method for a first wireless communication device to negotiate sharing of a communication medium with a second wireless communication device, the two devices not being under common control, the method comprising:

receiving a request to reserve the shared medium in an overlapping service area, wherein the reservation request comprises information identifying at least one address related to the first device and a first parameter characterising the requested reservation;

determining an acknowledgement type identifier based on at least the first parameter;

scheduling data communication via the shared medium based on the information identifying at least one address related to the first device; and

sending an acknowledgement of the reservation request comprising the acknowledgement type identifier and a second parameter characterising the requested reservation.

There may also be provided a computer program comprising program code that, when executed by a wireless communication device, causes the wireless communication device to:

determine the existence of an interference condition in an overlapping service area;

determine a set of devices related to the interference condition;

send a request to reserve a shared medium in the overlapping service area, wherein the reservation request comprises information identifying at least one of the determined set of devices and a first parameter characterising the requested reservation;

receive an acknowledgement from at least one of the devices identified in the reservation request, the acknowledgement comprising an acknowledgement type identifier and a second parameter characterising the requested reservation; and

schedule data communication via the shared medium based on the acknowledgement type identifier and at least one of the first parameter and the second parameter.

There may also be provided a computer program comprising program code that, when executed by a wireless communication device, causes the wireless communication device to:

receive a request to reserve a shared medium in an overlapping service area, wherein the reservation request comprises information identifying at least one address related to the wireless communication device and a first parameter characterising the requested reservation;

determine an acknowledgement type identifier based on at least the first parameter;

schedule data communication via the shared medium based on the information identifying at least one address related to the wireless communication device; and

send an acknowledgement of the reservation request comprising the acknowledgement type identifier and a second parameter characterising the requested reservation.

There may be provided a non-transitory computer-readable storage medium storing a computer program as described above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1A shows a schematic high-level block diagram of an 802.11 network arranged in an independent BSS (IBSS) configuration;

FIG. 1B shows a schematic high-level block diagram of an 802.11 network arranged in an infrastructure BSS configuration;

FIG. 2 shows a schematic diagram showing a plurality of 802.11 BSSs that are subject to overlapping BSS (OBSS) interference;

FIG. 3 shows a schematic diagram of an exemplary 802.11 frame comprising an Overlapping BSS Scan Parameters element;

FIG. 4A shows a schematic diagram of an exemplary 802.11 frame comprising a Resource Reservation Message (RRM), according to one or more embodiments of the present disclosure;

FIG. 4B shows a schematic diagram of an exemplary 802.11 frame comprising a Resource Reservation Acknowledgement (RRA), according to one or more embodiments of the present disclosure;

FIG. 5A shows a schematic diagram illustrating the case where two APs each have downlink data traffic to send to one or more of their associated STAs located in OBSS areas, according to one or more embodiments of the present disclosure;

FIG. 5B shows a schematic diagram illustrating the case where one AP has uplink data traffic to receive from and another AP has downlink data traffic to transmit to one or more associated STAs located in OBSS areas, according to one or more embodiments of the present disclosure;

FIG. 5C shows a schematic diagram illustrating the case where two APs each have uplink data traffic to receive from one or more of their associated STAs located in OBSS areas, according to one or more embodiments of the present disclosure;

FIG. 6 shows a flowchart of a method for a wireless communication device to reserve capacity of a medium shared with other wireless communication devices that are in an overlapping service area, according to one or more embodiments of the present disclosure;

FIG. 7 shows a flowchart of a method for a wireless communication device to negotiate reservation of a medium shared with a second wireless communication device requesting the reservation, according to one or more embodiments of the present disclosure;

FIG. 8 shows a schematic block diagram of an exemplary wireless communication device, such as an 802.11 station (STA), according to one or more embodiments of the present disclosure; and

FIG. 9 shows a schematic block diagram of an exemplary wireless communication device, such as an 802.11 station (STA) or access point (AP), according to one or more embodiments of the present disclosure.

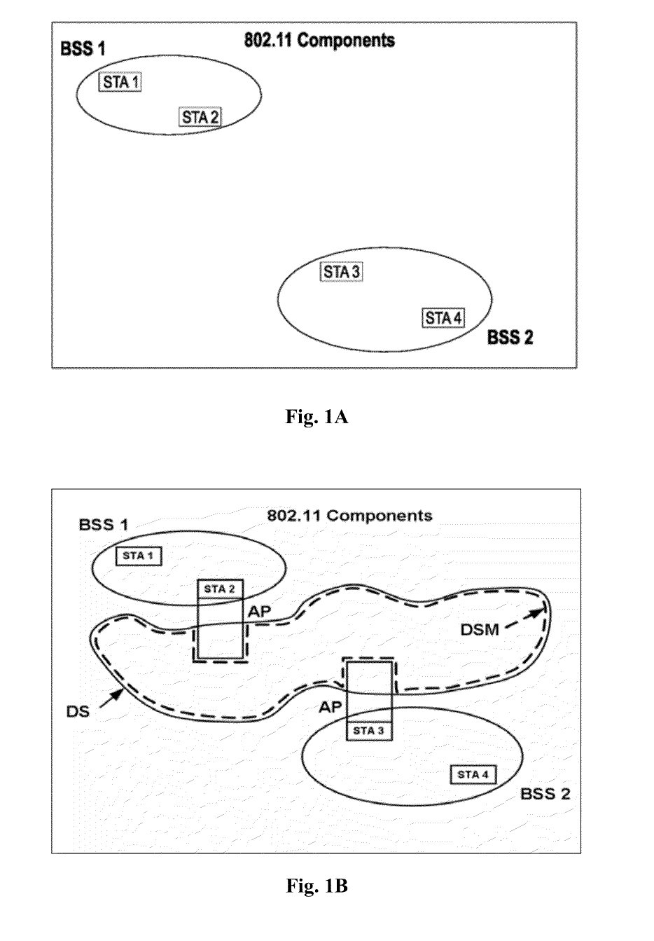

### DETAILED DESCRIPTION

As mentioned above, the distributed coordination function (DCF) of the 802.11 MAC layer enables STAs within a single BSS to automatically share the wireless channel among them. However, the presence of overlapping BSSs (OBSSs) may require additional measures. The 802.11 Standard defines an OBSS as a BSS operating on the same channel as a STA's BSS and either partly or wholly within the STA's basic service area (BSA). If the BSS and one or more OBSS are under common control or subject to network planning (e.g. in an office environment), they can be assigned non-overlapping frequency channels. In such a case, independent operation of the respective DCFs is sufficient to maintain desired data throughput in the respective BSSs. In many environments, however, the respective BSS/OBSS belong to or are operated by different individuals and/or organisations, so common control is not possible. Common scenarios include shopping malls, apartment buildings, or other dense residential or commercial areas. If a BSS and one or more OBSS are operating under such conditions on the same frequencies, the STAs in the respective BSS/OBSS are likely to experience a decrease in data throughput due to busy conditions and collisions on the shared or commonly-used channel medium.

The 802.11 RTS/CTS mechanism may work across BSS boundaries and can improve operation of many situations in which all STAs can receive from the AP. In cases where not all of STAs can receive from all other STAs in the BSS, however, the RTS/CTS may fail to solve some instances of OBSS. For example, if the STAs in the OBSS region of BSS1 have a lot of traffic, an STA associated with BSS2 but still able to hear transmissions from BSS1 may always find the medium busy and never attempt to send RTS messages. For such cases, other solutions are necessary.

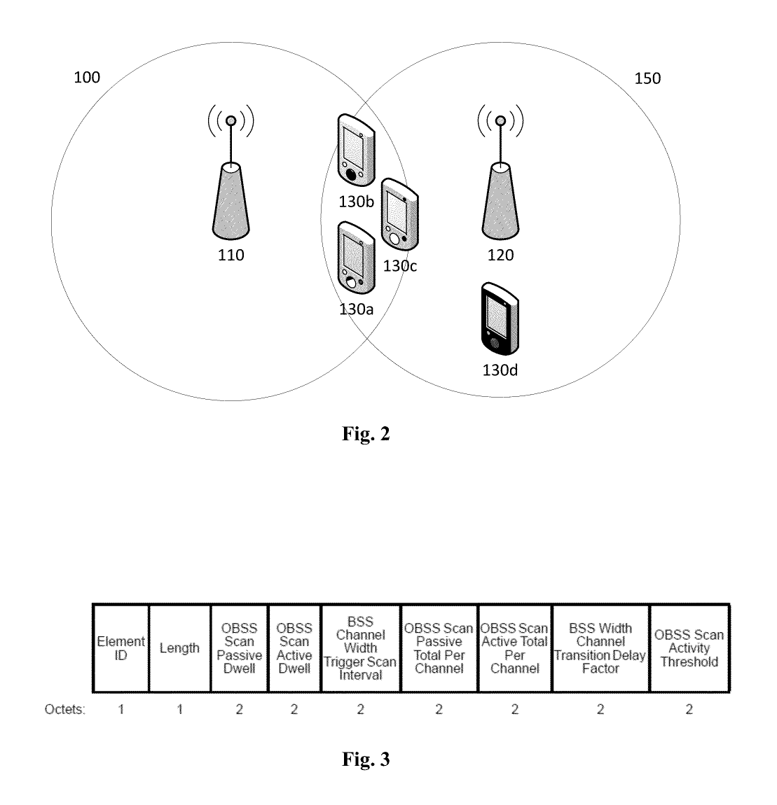

FIG. 2 is a block diagram showing a plurality of 802.11 BSSs that are subject to overlapping BSS (OBSS) interference, i.e. the so-called “OBSS problem”. In FIG. 2, access point (AP) 110 and STAs 130a and 130b are associated with BSS 100, while AP 120 and STAs 130c and 130d are associated with BSS 150. However, STAs 130a, 130b, and 130c are in the coverage area (i.e. BSA) of both BSS 100 and BSS 150. If STA 130a wants to transmit to AP 110 of BSS 100, it will sense the medium. If STA 130c happens to be transmitting to AP 120 of BSS 150, STA 130a will sense the commonly-used medium (i.e. frequency channel) as busy and will not be able to transmit at least until STA 130a has finished. The same will occur if STA 130a is transmitting and STA 130c senses the medium as busy. This can considerably reduce the STA-to-AP (i.e. uplink) throughput of BSS/OBSS configurations. Similarly, if AP 110 transmits to its associated STA 130a in BSS 100 at the same time as AP 120 transmits to its associated STA 130d, then the signal from AP 120 will collide and interfere with the reception of the signal from AP 110 by STA 130a. Since AP 110 will be unable to successfully transmit to STAs 130a and 130b when AP 120 is transmitting to STA 130c or 130d, these collisions can considerably reduce the AP-to-STA (i.e. downlink) throughput of BSS/OBSS configurations.

Although this problem exists for all 802.11 networks, it is particularly acute in 802.11 ah-compliant networks operating in the 1-GHz frequency range due to the greater propagation distances compared to 802.11 operations in higher frequencies such as 2.4 GHz. Moreover, any type of radio-frequency communications using a shared medium, whether in a licensed or an unlicensed frequency spectrum, without central control or coordination may be subject to the same general problem of reduced throughput due to interference. One example is Long Term Evolution (LTE) Device-to-Device (D2D) protocols standardised by the 3rd Generation Partnership Project (3 GPP).

Several attempts have been made at improving either the effectiveness of the individual surveillance devices or cooperative efficiency of the individual devices within a surveillance system. For example, US-B2-7792138 discloses a wireless LAN distributed/opportunistic schedule (WDOS) method for 802.11 networks that uses a modified RTS/CTS scheme to perform channel probing for multi-user scheduling based on respective channel conditions between the AP and various associated STAs. In this method, the AP sends an RTS with a broadcast address and receiving STAs calculate different back-offs to avoid multiple colliding CTS transmissions. The channel is reserved for data transmission between the transmitting AP and one of the STAs, all of which are in the same BSS.

US-A1-2012/0207036 discloses a method for requesting reservation of, and indicating status of, channel resources between a requesting device (e.g. an 802.11 AP) and a responding device (e.g. an 802.11 STA). The requesting device sends a resource request message on one radio channel requesting to reserve that channel between itself and the receiving device. The receiving device sends a resource response on the first channel including status of at least one additional radio channel that was not requested to be reserved by the requesting device. In this method, the reservation requests and responses are between two devices (e.g. an AP and an STA) in a single BSS and concern primary and one or more secondary channels of the transmission band of the BSS.

Currently, the 802.11 standard specifies requirements for STAs to perform OBSS scan operations. An OBSS scan operation is a passive or active scan of a set of channels that are potentially affected by 20/40 MHz BSS operation. Each channel in the set may be scanned more than once during a single OBSS scan operation. An AP triggers OBSS scanning operations by associated STAs when it transmits an

Overlapping BSS Scan Parameters element in a Beacon frame. An 802.11 frame comprising an exemplary Overlapping BSS Scan Parameters element is shown in FIG. 3. When included in a Management frame sent from the AP to one or more STAs, this element configures the STA's OBSS scanning operations, including duration of scans, interference thresholds, etc.

The 802.11 standard, as currently written, only requires the STAs to perform OBSS scanning upon receipt of the Overlapping BSS Scan Parameters element; it does not specify what an STA should do with the results of the scan. As disclosed in co-pending U.S. patent application Ser. No. 13/549,849 filed 16 Jul. 2012, the entire content of which is incorporated herein by reference, exemplary messages may be provided that enable the APs to request results of OBSS scans from associated STAs and receive such results in the form of an OBSS scan report. In this manner, each AP can determine, for example, which of its associated STAs are in the OBSS area of different BSSs, the STAs that interfere with these associated STAs, the APs associated with these different BSSs, and the amount or level of interference received from each.

For example, the OBSS scan report request from the AP may comprise parameters notifying an STA as to what the contents of the OBSS scan report should contain. The OBSS scan report request may include a variety of information about the channel environment of the network. For example, the OBSS scan report request may indicate that any, some, or all of the following information should be provided by an STA in an OBSS scan report: number of SSIDs and/or BSSIDs detected; names of each detected SSID/BSSID; interference levels of each detected SSID/BSSID; existence and/or contents of an OBSS message on the same channel; sector/area where the STA is located (e.g. if an AP's coverage area is divided into sub-areas); absolute geographical location of the STA (determined, e.g. by a Global Positioning System (GPS) receiver); location of the STA relative to the AP; path loss between the STA and the AP. Persons of ordinary skill will readily understand that this list is non-exhaustive and exemplary, and that other parameters useful in embodiments of the present disclosure may be included in the OBSS scan report request and in the subsequent OBSS scan report.

The OBSS scan report request may also include reporting format instructions, such as a configuration option to instruct the STA to use a specific frame subtype to indicate the presence of an OBSS without providing additional metadata about the OBSS, by sending a frame with a particular sub-frame type (e.g. a data+OBSS indication or control+OBSS indication type sub-frame). The reporting format instructions may be related to or based on the type of 802.11 wireless networks or the type of STAs active in the network. For example, in scenarios including one or more low-power, battery-operated STAs, it may be advantageous to minimise the number of requested parameters to reduce STA energy consumption. In networks where the STAs are not dependent upon internal batteries, more data may be requested to obtain a clearer picture of the network environment.

The AP may transmit the parameters comprising the OBSS scan report request to one or more STAs in a variety of ways. For example, the AP may notify an STA of the parameters at the time the STA associates with the AP's BSS. Alternatively, the AP may periodically transmit a beacon frame containing the parameters. As yet another alternative, the AP may directly transmit the OBSS scan report request to an STA in a particular type of frame, such as a Management frame. As a further alternative, the AP may indicate that the network utilises a configurable set of parameters in a beacon frame or during the network join process, with the OBSS scan report request sent in a different message.

Upon receiving one or more responsive OBSS scan reports from associated STAs, the AP may utilise the contents to update an OBSS database. The OBSS database may comprise information related to one or more of the STAs associated with the AP, as well as information related to the AP itself. For example, for each particular STA associated with the AP that has provided an OBSS scan report, the OBSS database may include a corresponding record that includes a list of all the other BSSs for which that STA is in an OBSS area, the STAs within these other BSSs that are interfering with the particular STA, and the respective interference levels. In addition, the OBSS database may comprise a list of the interfering APs associated with the overlapping BSSs and their respective interference levels. Besides the OBSS information that the AP keeps in the OBSS database regarding its associated STAs, the AP can further collect similar information regarding itself. It can therefore update the OBSS database indicating STAs and other BSSs/APs interfering with it as well as the corresponding interference levels. This information is available to the AP, for instance, as a result of its medium-sensing activities. The OBSS database may comprise other information contained in the OBSS scan reports provided by the STAs, including but not limited to the list enumerated above.

Embodiments of the present disclosure solve the problems of throughput reduction due to collisions, busy medium, and deferred transmission discussed above in relation to overlapping wireless networks (e.g. 802.11 overlapping BSS (OBSS)) by allowing also the STAs suffering from OBSS interference to have sufficient chances to transmit and/or receive successfully. Embodiments of the present disclosure include methods for a first wireless communication device (e.g. an 802.11 AP) to transmit or receive data via a channel or medium shared with other wireless communication devices (e.g. 802.11 APs and/or STAs) that are in overlapping service areas with the first device but not under common control (e.g. in a different 802.11 BSS). The first wireless device determines the existence of an interference condition in an overlapping service area. If such an interference condition exists, the first device determines a list of interfering wireless devices in the overlapping service area. The list of interfering devices may comprise 802.11 APs and/or STAs operating in the same channel as the first device. Subsequently, the first device sends a resource reservation message to at least a portion of the interfering devices comprising the list, requesting reservation of the shared channel or medium in the overlapping service area. The resource reservation message may comprise one or more other parameters related to the duration, periodicity, and/or transmission direction of the reservation. The first device may receive acknowledgement messages from the devices to which the request message was directed. The acknowledgement message may comprise a positive acknowledgement, such as an accept request or an accept request with modifications, or a negative acknowledgement, such as a reject request. Upon receiving a positive acknowledgement, the first device transmits or receives data according to the parameters of the reservation. Embodiments include a wireless communication device (e.g. 802.11 AP) and a computer program or a computer-readable medium with program code embodying one or more of these methods.

Embodiments of the present disclosure also include methods for a first wireless communication device (e.g. an 802.11 AP) to negotiate reservation of a resource (e.g. a wireless channel or medium) that is shared with a second wireless communication device requesting the reservation (e.g. and 802.11 AP), the two devices being in overlapping service areas but not under common control. The first device receives a resource reservation message from the second device requesting reservation of the shared channel or medium in the overlapping service area. The resource reservation message may comprise information identifying the first device and/or one or more other devices (e.g. 802.11 STAs) associated with the first device, together with one or more other parameters related to the duration, periodicity, and/or transmission direction of the reservation. The first device may determine whether the duration and/or periodicity requested for the channel reservation is acceptable to it and, if not, whether other durations and/or periodicities would be acceptable. The first device also may determine a required offset to the beginning of the requested channel reservation. The first device may also determine whether any data traffic is pending for its associated devices not identified in the resource reservation message and, if so, schedule transmission of that data traffic prior to sending an acknowledgement message to the second device. Embodiments include a wireless communication device (e.g. 802.11 AP) and a computer program or a computer-readable medium with program code embodying one or more of these methods.

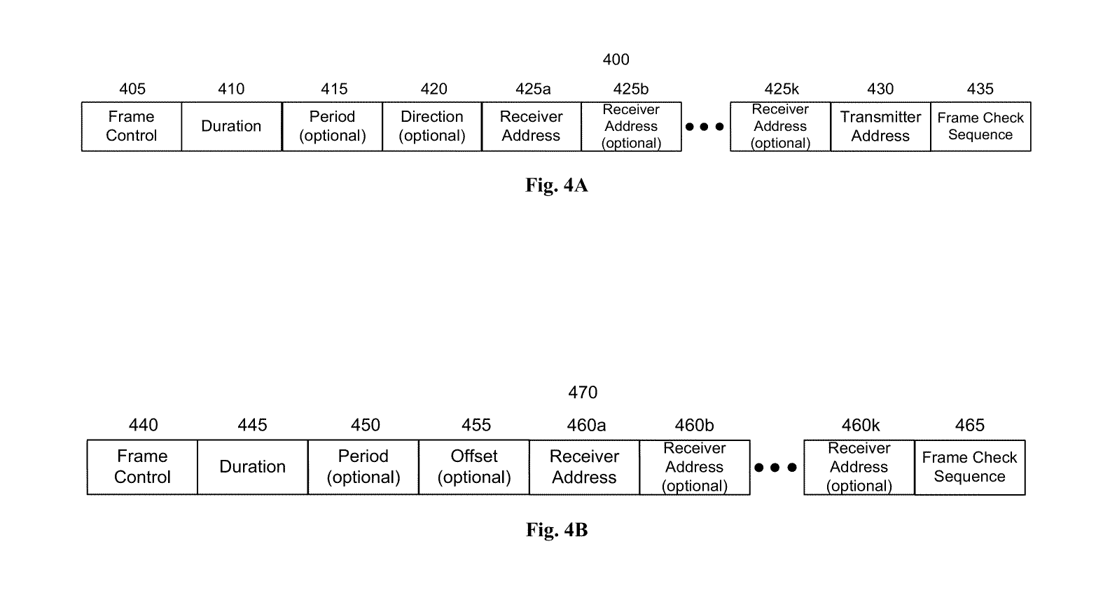

FIG. 4A is a diagram of an exemplary 802.11 MAC frame 400 comprising a Resource Reservation Message (RRM) according to various embodiments of the present disclosure. Mandatory fields of frame 400 include Frame Control 405, Duration 410, Receiver Address 425a, Transmitter Address 430, and Frame Check Sequence 435. One or more of Period field 415, Direction field 420, and Receiver Address fields 425b through 425k may be present depending on the embodiment.

Frame Control field 405 comprises various subfields including Protocol Version, Type, Subtype, To DS, From DS, More Fragments, Retry, Power Management, More Data, Protected Frame, and Order. The Type (two bits) and Subtype (four bits) fields together identify the function of the frame. There are three frame types, control, data, and management, each of which has several defined subtypes. The RRM message can be indicated by, for example, using the two bits indicating a “Control” frame type and the Subtype values 0000-0110 currently reserved in the 802.11 standard. Alternatively, the RRM message can be indicated by using the currently reserved “11” value for the Type subfield along with any of the corresponding reserved Subtype values 0000-1111. By using appropriate combinations of Type/Subtype values, the particular format of an RRM message can be characterised (e.g. the presence of single or multiple addresses, the presence of a Period field, etc.). Frame Check Sequence 435 comprises data computed from the remainder of the frame using a known algorithm, which may be applied to the received frame to detect errors occurring during transmission, as known to persons of ordinary skill in the art.

Transmitter Address 430 comprises the 802.11 address (e.g. MAC address) of the AP transmitting the RRM. Alternatively, to reduce the number of required bits needed to represent the MAC address, it is possible for example to use the Association Identifier (AID) or the partial AID for this purpose. Receiver Address field 425a comprises the address of one or more intended recipients of the RRM comprising frame 400. In some embodiments, Receiver Address 425a may comprise the address of the AP of an overlapping BSS (OBSS), and in such a case the RRM is intended only for this AP. In other embodiments, Receiver Address 425a may comprise the address of an interfering STA in an OBSS; in such a case, the intended recipient is the AP associated with the interfering STA. In other embodiments, Receiver Address 425a may comprise a broadcast receiver address such that all APs receiving the RRM will recognise that it is intended for them. In other embodiments, Receiver Address 425a comprises a group address/number corresponding to an interfering group of AP/STAs in a neighbouring BSS, denoting that the RRM is intended for the AP of the interfering group.

Depending on the embodiment, frame 400 may comprise additional Receiver Address fields 425b through 425k, respectively. The number of Receiver Address fields, represented by the variable “K”, may be as low as one (1), in which case

Receiver Address fields are not present, and as high as allowed by any size constraints of frame 400. In some embodiments, Receiver Address fields 425a through 425k may comprise all the addresses of APs and/or STAs that one or more associated STAs reported as interfering. In such cases, the intended recipients of the RRM include both the APs whose addresses appear in fields 425a through 425k and the APs associated with the STAs whose addresses appear in these fields. In some embodiments, where the number of interfering APs and/or STAs is large, fields 425a through 425k may comprise addresses of the K APs and/or STAs reported by associated STAs as having the highest interference levels. In such embodiments, the value K may be time-varying depending on the load and amounts of interference.

In some embodiments, the AP may determine fields 425a through 425k of frame 400 based on an interference threshold. For example, the AP may identify the minimum set of STAs and/or APs from its OBSS database whose total interference meets or exceeds the interference threshold. The AP then includes the addresses of the APs and/or STAs from that set in fields 425a through 425k.

Frame 400 may comprise a Duration field 410, which represents the duration, T, of the requested resource reservation, expressed in terms of beacon intervals or other system time units (TUs). The units of Duration field 410 may be fixed and, in such a case, implicitly understood between the sending AP and the intended recipients. Alternatively, the field 410 may explicitly indicate the units of T either as a separate sub-field or in conjunction with the value of T. In some embodiments, a scaling factor, S_{T}, can be used to account for larger values. The presence and/or value of the scaling factor, S_{T}, can be indicated, for example, by particular values in one or more of the Type and Subtype fields, as discussed above. In such embodiments, the total duration is implicitly understood between the sending AP and intended recipients to be the product of T and S_{T}. In some embodiments, the total duration, scaled or not, represents the amount of time that the one or more intended AP recipients of the RRM of frame 400 should completely defer transmission to and reception from their associated STAs. Thus, during the total duration, only a single BSS can operate while those BSSs interfering with it must remain silent. For example, the presence of Duration field 410 in conjunction with only AP address(es) (i.e. no STA addresses) in Receiver Address fields 425a through 425k may be used to indicate the receiving APs should interpret the RRM in this manner.

In some embodiments where Receiver Address fields 425a through 425k comprise one or more STA addresses, the total duration represents that amount of time that the intended AP recipients should defer transmission to and reception from their associated STAs included in fields 425a through 425k. In such cases, during the total duration, these APs may transmit to and receive from associated STAs whose addresses are not included in the RRM. This allows for better channel utilisation as both APs can use the overlapping channel concurrently.

In some embodiments, frame 400 may comprise a Period field 415, which indicates that the AP sending frame 400 requests control of the shared channel for a duration T (specified in field 410) out of every period P units of time. The units of Period field 415 may be fixed and, in such a case, implicitly understood between the sending AP and the intended recipients. Alternatively, the field 415 may explicitly indicate the units of T either as a separate sub-field or in conjunction with the value of P. In some embodiments, a scaling factor, S_{P}, can be used to account for larger values. The presence and/or value of the scaling factor, S_{P}, can be indicated, for example, by particular values in one or more of the Type and Subtype fields, as discussed above. In such embodiments, the total period is implicitly understood between the sending AP and intended recipients to be the product of P and Sp. Moreover, a RRM comprising Duration field 410 and Period field 415, and any associated scaling factors, may be implicitly understood by the sending and receiving APs as a request for using the overlapping channel for a (T·S_{T})/(P·S_{P}) duty cycle indefinitely, or at least until a subsequent RRM containing different parameters is sent.

In some embodiments, frame 400 may comprise a Direction field 420, which represents the transmission direction of the traffic for which the AP is requesting to reserve to shared channel. For example, a value of “0” may indicate uplink traffic (STA to AP) while a value of “1” may indicate downlink traffic (AP to STA), or vice versa. Other values may be used to indicate that the reservation is for bidirectional traffic. Alternatively, the absence of Direction field 420 may indicate that the reservation is for bidirectional traffic.

FIG. 4B is a diagram of an exemplary 802.11 MAC frame 470 comprising a Resource Reservation Acknowledgement (RRA) according to various embodiments of the present disclosure. RRA messages according to these embodiments are sent by an AP in response to receiving an RRM from a sending AP, and are configured responsively to the contents of the received RRM. Mandatory fields of frame 470 include Frame Control 440, Duration 445, Receiver Address 460a, and Frame Check Sequence 465. One or more of fields Period 450, Offset 455, and Receiver Address 450b through 450k may be present depending on embodiment. Frame Control field 440 and Frame Check Sequence 465 have substantially the same function as described above with respect to frame 400 in FIG. 4A.

One or more of the Type and/or Subtype sub-fields of Frame Control field 440 may be used to indicate whether frame 470 comprises an RRA with an “accept”, an “accept with modifications”, or a “reject.” For example, as with the RRM, the different types of RRA message can be indicated using the two bits expressing a frame of type “Control” and the reserved subtype values 0000-0110. Alternatively, the different types of RRA message can be also indicated by using the two bits 11 of the type description which are currently reserved along with any of their corresponding reserved subtype values 0000-1111. Different values in the type subtype fields can for instance specify the type of RRM, e.g. if it is an “accept”, a “reject”, an “accept with modifications”, “period is included”, etc. In the event that the AP is willing to agree to share the overlapping channel according to the parameters comprising the RRM, it responds to the sending AP with a frame 470 comprising an “accept” RRA. In such a case, the responding AP fills the Duration field 445 of the RRA with the contents of Duration field 410 from the received RRM, and fills Receiving Address field 460a with its own address. In the same manner, if the RRM comprised a Period field 415, the responding AP fills the Period field 450 of the RRA with the contents of Period field 415.

In some situations, such as during high-traffic periods, the receiving AP may not be willing to agree to any type of deferment or sharing of the overlapping channel with the sending AP. In such a case, the receiving AP responds to the sending AP with a frame 470 comprising a “reject RRM” RRA. In such a case, the responding AP fills the Duration and Period fields 445 and 450, respectively, with the contents of corresponding fields (i.e. 410 and 415) present in the received RRM. Similarly, the responding AP fills Receiving Address field 460a with its own address. Alternatively, the responding AP may fill the Duration field 445 of the RRA with a value of “0” (zero) for the duration to signal non-acceptance of the Duration parameter, in which case no time will be reserved. Similarly, the responding AP may fill the Period field 450 with a value of “0” (zero) to indicate non-acceptance of the Period value included in the RRM.

In some situations, the receiving AP may not be agreeable to share the overlapping channel with the sending AP according to the parameters comprising the RRM, but is able to share the channel according to other parameters. In such a case, the receiving AP responds to the sending AP with a frame 470 comprising an “accept with modifications” RRA and a Duration field 445 comprising a duration, T′, for which the receiving AP is willing to relinquish control of the overlapping channel to the sending AP. The receiving AP also may include Period field 450, which may comprise the same value, P, or a different value, P′, as received in Period field 415 of the RRM. For example, the period requested by the sending AP may be too frequent and beyond the capability of the receiving AP if the latter has a lot of traffic. In some embodiments, the receiving AP may also include Period field 450 even if the Period field 415 was not present in the RRM, for example to propose sharing the overlapping channel on a periodic basis rather than relinquishing it for a duration, T.

In some situations, the receiving AP may be agreeable to sharing the overlapping channel according to the parameters comprising the RRM, but may require use of the channel for a short duration prior to relinquishing it to the requesting AP for the requested duration, T. This may occur, for example, if the receiving AP has scheduled data traffic that is time-sensitive or relatively small compared with the amount of traffic that could be sent by the requesting AP during T. In such a case, the receiving AP may respond to the requesting AP with a frame 470 comprising an “accept with modifications” RRA and an Offset field 455 comprising an amount of time, M, for which the shared channel is required prior to relinquishing control for the requested duration, T. The value of M may represent an offset from the present system time, taking into account any propagation delays of the RRA between the receiving AP and the requesting AP. After receiving an RRA with such an Offset field 445, the requesting AP may begin using the channel at the system time corresponding to M, and continue until a system time corresponding to T+M.

Depending on the embodiment, the receiving AP may also include in the RRA one or more Receiver Address fields 460a through 460k. For example, the receiving AP may include Receiver Address fields corresponding to its own address and addresses of one or more of its associated STAs. By way of further illustration, in situations involving multiple overlapping BSSs, the RRM may comprise addresses identifying multiple APs and/or STAs associated with multiple BSSs. In such a case, a receiving AP may respond with an RRA comprising only its own address and/or addresses of its associated STAs that were identified in by the Receiver Address fields of the RRM.

The order in which intended recipients of the RRM respond to the sending AP can depend on several factors. In some embodiments, the order of response may be determined directly (or inversely) based on the AP order in the RRM so that APs that are listed first (or last) in the message have a shorter average backoff time prior to responding. In these embodiments, this effect can be achieved by setting the minimum backoff window to be sequentially increasing (or decreasing) in the order that the APs appear in the RRM. Alternatively, the maximum backoff window can be sequentially decreasing (or increasing) in the order that the APs appear in the RRM. Alternatively, a weighting function may be determined based on the order of appearance in the RRM. In such a case, although the minimum and maximum backoff windows are held constant for all APs, applying a higher weight to the APs that appear first in the message effectively reduces the average backoff. In some embodiments, the response order can be determined based on the APs' AID or MAC addresses, in either ascending or descending order. Like the other embodiments described previously, this effect can be achieved by controlling the minimum and maximum backoff windows as well as by scaling the random backoff.

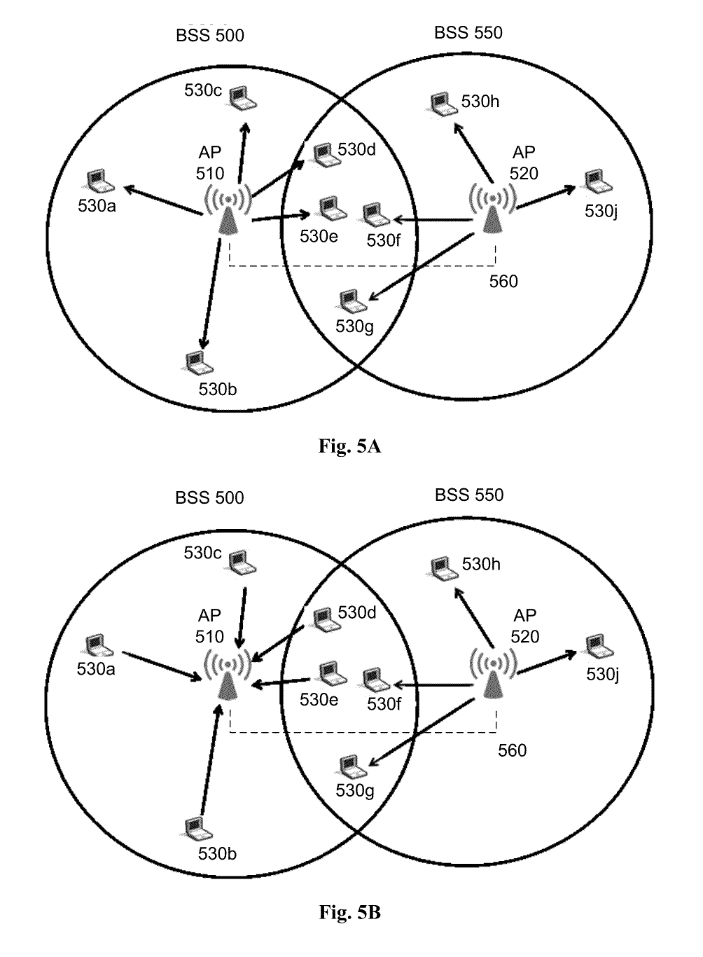

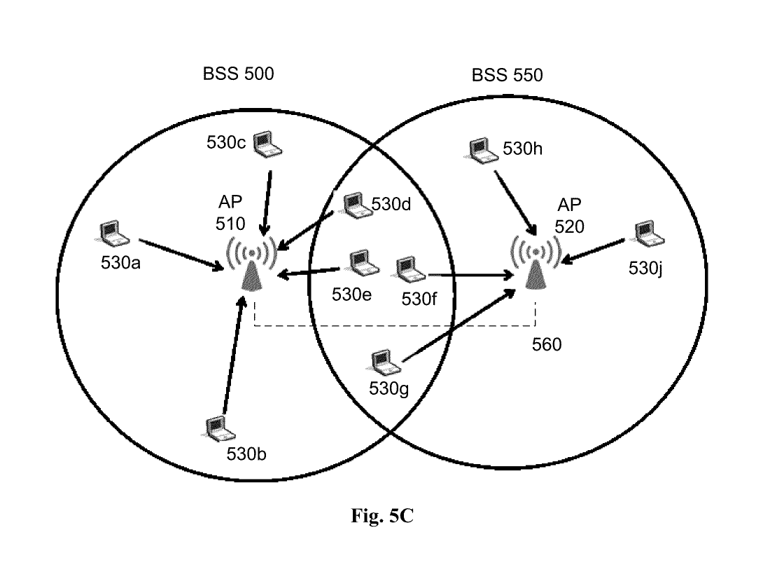

Operations of various embodiments of the present disclosure will now be described with reference to FIGS. 5A through 5C. Each of these figures shows schematically a diagram of two overlapping BSSs: BSS 500 comprising AP 510 and associated STAs 530a, b, c, d, and e; and BSS 550 comprising AP 520 and associated STAs 530f, g, h, and j. STAs 530d, e, f, and g are located in the overlapping region of the two BSSs and subject to interference from the non-associated BSS (e.g. STAs 530d and e from BSS 550). In these figures, APs 510 and 520 are capable of receiving messages from each other, either over the shared overlapping wireless channel or via an optional wired connection 560 between them. FIG. 5A illustrates the case where both AP 510 and AP 520 have downlink data traffic to send to one or more of their associated STAs. One of the APs, e.g. AP 510, checks its OBSS database to determine whether an associated STA targeted for downlink traffic suffers from OBSS interference. If AP 510 determines that the STA does not suffer from OBSS interference, it proceeds to transmit the data traffic to the STA. This would be the case, for example, with STA 530a.

On the other hand, if the AP 510 determines that the targeted STA suffers from OBSS interference, it determines the interfering AP and/or STAs from the information in the database. This would be the case, for example, with STA 530e, which suffers from OBSS interference from STAs 530f and g and AP 520 of BSS 550. Similarly, STA 530d would suffer from OBSS interference from STAs 530f and g and AP 520. AP 510 then composes a Resource Reservation Message (RRM) comprising the addresses of these interfering units and the duration that AP510 needs the overlapping channel, and sends the RRM to AP 520. AP 510 may optionally include a period in the RRM if periodic use of the channel is desired. If able to delay potentially interfering downlink traffic, AP 520 will respond with an RRA “accept request” allowing the first AP to transmit its traffic. After responding with the RRA, AP 520 may either remain idle during the reserved duration or, alternatively, transmit downlink data traffic to associated STAs other than the one(s) identified in the RRM. For example, AP 520 could transmit downlink traffic to STAs 530h and/or 530j during the reserved duration using, for example, a directional antenna to avoid interfering with AP 510. If for any reason AP 520 does not respond, AP 510 will retransmit the RRM after a time-out. After relinquishing the overlapping channel for the specified duration, AP 520 may take substantially the same actions to reserve the channel for sending its pending downlink traffic.

FIG. 5B illustrates the case where AP 510 has uplink traffic to receive and AP 520 has downlink data traffic to send to one or more of their associated STAs. AP 510 checks its OBSS database to determine whether an associated STA scheduled to send uplink traffic suffers from OBSS interference. If AP 510 determines that the scheduled STA does not suffer from OBSS interference, it allows the STA to transmit the data traffic. On the other hand, if the AP 510 determines that the scheduled STA suffers from OBSS interference, it determines the interfering AP and/or STAs from the information in the database. This would be the case, for example, with STA 530e (or STA 530d), which suffers from OBSS interference from STAs 530f and g and AP 520 of BSS 550. AP 510 then composes a Resource Reservation Message (RRM) comprising the addresses of these interfering units and the duration that AP510 needs to reserve the overlapping channel, and sends the RRM to AP 520. AP 510 may optionally include a period in the RRM if periodic use of the channel is desired.

If able to delay its potentially interfering downlink traffic, AP 520 will respond with an RRA “accept request” to the first AP. If for any reason AP 520 does not respond to AP 510's RRM, AP 510 will retransmit the RRM after a time-out. After responding with the RRA, AP 520 may remain idle during the reserved duration or, alternatively, transmit downlink traffic to associated STAs other than the one(s) identified in the RRM. For example, AP 520 could transmit downlink traffic to STAs 530h and/or 530j during the reserved duration using, for example, a directional antenna to avoid interfering with AP 510. After the specified duration, AP 520 may take substantially the same actions to reserve the channel for data transmission by STAs identified in the RRM.

FIG. 5C illustrates the case where both AP 510 and AP 520 have uplink traffic to receive from one or more of their associated STAs. AP 510 checks its OBSS database to determine whether one or more associated STAs scheduled to send uplink traffic suffer from OBSS interference. If AP 510 determines that the one or more scheduled STAs do not suffer from OBSS interference, it allows them to transmit their uplink traffic. On the other hand, if the AP 510 determines that the one or more scheduled STAs suffer from OBSS interference, it determines the interfering AP and/or STAs from the information in the database. This would be the case, for example, with STA 530e, which suffers from OBSS interference from STAs 530f and g and AP 520 of BSS 550. AP 510 then composes a Resource Reservation Message (RRM) comprising the addresses of these interfering units and the duration that AP 510 needs to reserve the overlapping channel, and sends the RRM to AP 520. AP 510 may optionally include a period in the RRM if periodic use of the channel is desired.

If able to delay the potentially interfering uplink traffic from its associated STAs, AP 520 will respond with an RRA “accept request” to the first AP. If for any reason AP 520 does not respond to AP 510's RRM, AP 510 will retransmit the RRM after a time-out. After responding with the RRA, AP 520 may either instruct all associated STAs with uplink traffic to remain idle during the reserved duration or, alternatively, allow associated STAs other than those identified in the RRM to transmit their uplink data traffic. For example, AP 520 could allow STAs 530h and/or 530j to transmit data traffic during the duration reserved by AP 520. Alternatively, AP 520 may group the STAs in the OBSS region in a single group whose access to the medium may be commonly allowed or restricted by AP 520. For example, a group of STAs can attempt transmission according to the DCF when AP 520 reserves in reciprocity the channel for its own operations. After the specified duration, AP 520 may take substantially the same actions to reserve the channel to receive pending uplink traffic from STAs identified in the RRM.

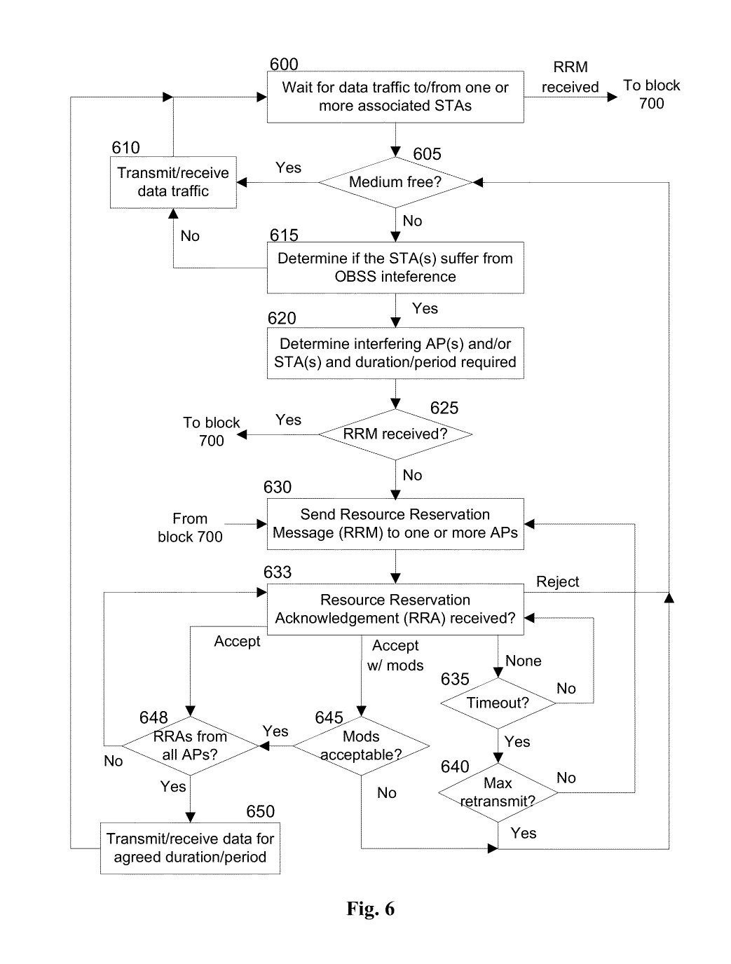

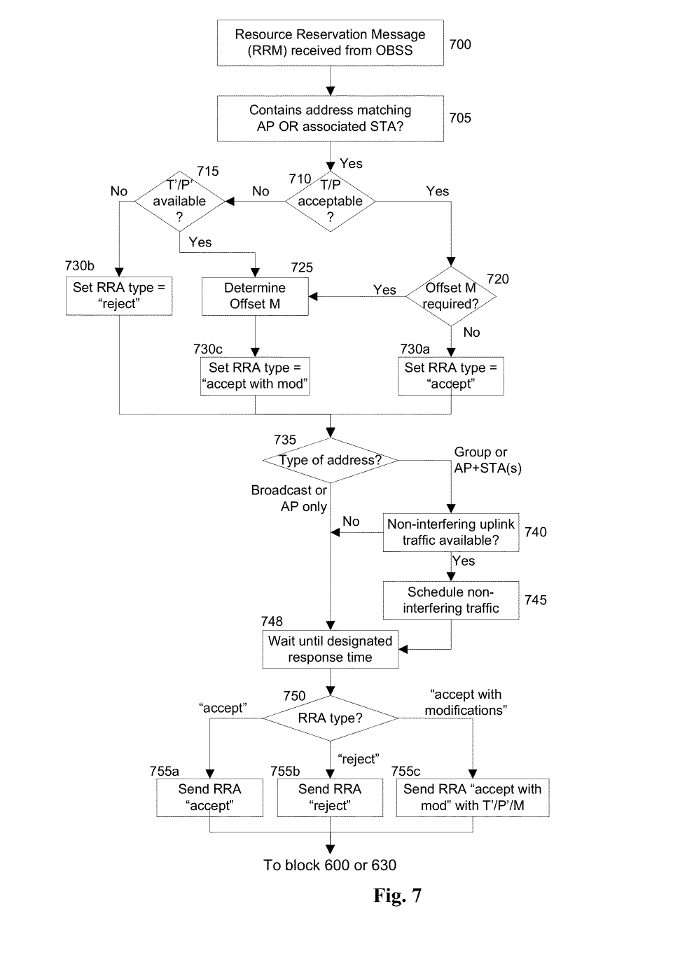

FIG. 6 is a flowchart of a method for a first wireless communication device (e.g. an 802.11 AP) to reserve capacity of a medium (e.g. a wireless channel) that is shared with other wireless communication devices (e.g. 802.11 APs and/or STAs) that are in overlapping service areas with the first device but not under common control. Although the method is illustrated in FIG. 6 by blocks in a particular order, this order is merely exemplary and the steps of the method may be performed in a different order than shown by FIG. 6, and may be combined and/or divided into blocks having different functionality. In block 600, the device utilising the method of FIG. 6, referred to below as “the device”, waits for the availability of data traffic to send to or receive from one or more of its associated STAs. If the device receives a Resource Reservation Message (RRM) from another device while waiting in block 600, it proceeds instead to block 700 of the method shown in and described below with reference to FIG. 7. When data traffic is available, the device proceeds to block 605 where it checks if the shared medium is free. If so, it proceeds to block 610 where it either transmits the downlink data or schedules transmission of uplink data from the one or more associated STAs. After completion, the device returns to block 600.

On the other hand, if the device determines that the medium is not free, it proceeds to block 615 where it determines if the associated STAs for which data traffic is pending suffer from OBSS interference. The operation of block 615 may be performed in various ways. For example, the device may access an OBSS database stored locally in its memory or in a remote location accessible to the device. The OBSS database may comprise interference information previously reported by the STAs in response to requests by the device, as described in detail above. If no database is available, or if the particular STAs do not have corresponding entries in the database, then the device may request and receive such information from them in block 615.

In other embodiments, the device may determine the existence of OBSS interference in block 615 first by receiving signals transmitted by one or more APs on the shared medium of the overlapping service area, and determining a first set of BSSIDs identified in the signals received from the APs. Next, the device receives signals transmitted by one or more STAs on the shared medium of the overlapping service area, and determines a second set of BSSIDs identified in the signals received from the STAs. If the second set contains BSSIDs not present in the first set, then the device determines that OBSS interference exists in the overlapping service area. In such embodiments, the operation of block 615 may be performed prior to or in conjunction with any of the blocks preceding block 615, such as while waiting for data traffic in block 600, with the result of the operation being stored for later use

If the device determines that the particular STAs do not suffer from OBSS interference, then it proceeds to block 610 for transmission or scheduling of reception, as described above. On the other hand, if the device determines that the particular STAs do suffer from OBSS interference, it proceeds to block 620 where it determines an interfering list of devices in one or more neighbouring networks (e.g. BSS). The interfering devices may be 802.11 APs and/or 802.11 STAs. The interfering list may comprise all the interfering APs and/or STAs, or a particular subset of them, which may be determined based on various criteria as described in detail above. Also in block 620, the device determines the duration, T, for which it wants to reserve the shared medium. The duration T may be determined based on the amount of pending data traffic and an estimated channel throughput, or by other methods known to persons of ordinary skill in the art. In block 620, the device also may determine a period, P, in conjunction with the duration, T. As discussed above, the combination of T and P specifies that the device wishes to reserve the shared medium for T out of every P time units until cancelled. Unless otherwise specified, one or more of the values for the duration, T, and period, P, may comprise a scale factor as discussed previously with reference to FIG. 4A.

Once the interfering list and other parameters are determined, the device proceeds to block 625 where it determines whether it has received a RRM from another device. If so, it proceeds to block 700 of the method shown in and described below with reference to FIG. 7. If not, the device proceeds to block 630 where it transmits a RRM on the shared medium. The RRM may comprise information from which the devices on the interfering list determined in block 620 may be recognised by recipients of the RRM. For example, the RRM may comprise one or more of the Receiver Address fields shown in and described above with reference to FIG. 4A. The RRM also may comprise the duration and, optionally, period values determined in block 620.

The device then proceeds to block 633, where it determines whether it has received a Resource Reservation Acknowledgement (RRA) in response to the RRM sent in block 633. If it determines that no RRA has been received, it proceeds to block 635 where it checks to see if a reception timeout has occurred. If not, it returns to block 633 where it continues to wait for the RRA. If the device determines that a timeout has occurred, it proceeds to block 640 where it determines if the maximum number of retransmissions has already been reached. If not, it increments the retransmission counter and then returns to block 630 where it sends another RRM to the same intended recipients as the previous RRM. If the maximum number of retransmissions has already occurred, the device returns to block 605 where it waits for the medium to become free. Similarly, if the device determines in block 633 that it received an RRA “reject”, it returns to block 605 where it waits for the shared medium to become available.

If the device determines in block 633 that it received an RRA “accept”, it proceeds to block 648 where it determines whether it has received a positive RRA response (i.e. “accept” or “accept with modifications” with acceptable parameters) from all of the APs identified in the contents of the RRM sent in block 630. If so, the device proceeds to block 650 where it either transmits downlink data or schedules transmission of uplink data from the one or more associated STAs according to the agreed-upon duration, T, and (optionally) period, P. After completion, the device returns to block 600. If the device determines in block 648 that it has not received positive RRA responses from some of the AP's identified in the RRM, it returns to block 633 where it waits to receive RRA responses from these APs.

Alternatively, if the device determines in block 633 that it received an RRA “accept with modifications”, it proceeds to block 645 where it determines whether the modified duration, T′, and (optionally) period, P′ in the RRA are acceptable. If not, the device returns to block 605 where it waits for the shared medium to become available. If the received RRA parameters are acceptable, the device proceeds to block 648 where it determines whether it has received a positive RRA response from all the AP's identified in the RRM message sent in block 630, as described above. If so, the device proceeds to block 650 where it either transmits downlink data or schedules transmission of uplink data from the one or more associated STAs according to the duration, T′, and (optionally) period, P′.

FIG. 7 is a flowchart of a method for a first wireless communication device (e.g. an 802.11 AP) to negotiate reservation of a resource (e.g. a wireless channel or medium) shared with a second wireless communication device requesting reservation (e.g. and 802.11 AP), the two devices being in overlapping service areas but not under common control. Although the method is illustrated in FIG. 7 by blocks in a particular order, this order is merely exemplary and the steps of the method may be performed in a different order than shown by FIG. 7, and may be combined and/or divided into blocks having different functionality. In block 700, the device utilising the method of FIG. 7, referred to below as “the device”, determines that it has received a Resource Reservation Message (RRM) from another device, referred to below as “the requesting device”. In block 700, the device determines whether the RRM contains an address that corresponds to its own address, or to an address of one or more of its associated STAs. For example, as described in more detail above with reference to FIG. 4A, the RRM may contain only the device's own address, the address of the device and one or more addresses of associated STAs, a Broadcast address, or a Group address corresponding to one or more associated STAs. If the device determines in block 705 that there is no address match, then it returns to where it was when it received the RRM, e.g. block 600 or block 630 in FIG. 6.

If the device determines in block 705 that there is an address match in the RRM, then it proceeds to block 710 where it determines whether the requested reservation parameters, duration T and (optionally) period P, are acceptable. This determination may be made based on the amount of uplink and/or downlink data traffic that the device has pending, taking into account an estimated channel throughput or capacity per time unit. If the device determines that parameters T/P are acceptable, it proceeds to block 720 where it determines if an offset, M, to the starting time of the duration, T, is required. This determination may be made, for example, in consideration of the amount of uplink and/or downlink traffic pending for the device as well as the requested duration, T. If an offset is required, the device proceeds to block 725; if not, the device proceeds to block 730a where it sets the RRA type equal to “accept”.

On the other hand, if the device determines that the parameters T/P are not acceptable, it proceeds to block 715 where it determines whether there are alternative reservation parameters T′, for duration, and (optionally) P′, for periodicity, that would be acceptable. This determination may be made based on the amount of uplink and/or downlink data traffic that the device has pending, taking into account an estimated channel throughput or capacity per time unit. For example, the device may determine that it is willing to allow the requesting device to reserve the shared channel for a duration T′<T, or that it is willing to allow the requesting device to periodically reserve the channel for a duration T′ out of every period P′, where T′<T and P′>P. The device then proceeds to block 725 where it determines the offset, M, required to the starting time of the duration, T. The offset may be determined, for example, based on the amount of uplink and/or downlink traffic pending for the device. Subsequently, the device proceeds to block 730c where it sets the RRA type equal to “accept with modifications”. Alternatively, if the device determines that no alternative reservation parameters are acceptable, it proceeds to block 730b where it sets the RRA type equal to “reject”.

In any case, the device then proceeds to block 735 where it determines the type of address(es) for which it determined a match in block 705. If the device determines that the match was for a broadcast address or for the only the device's own address, then it proceeds to block 750. Alternatively, if the device determines that the match was for a group of its associated STAs, or for the device's address and addresses of one or more of its associated STAs, then it proceeds to block 740. In block 740, the device determines whether there is any uplink data traffic pending in one or more of its associated STAs that would not interfere with the requested reservation. If such traffic is determined to exist, then the device proceeds to block 745 where it schedules the transmission of the uplink traffic by the non-interfering STAs, then on to block 748. On the other hand, if no non-interfering uplink traffic exists, then the device proceeds directly to block 748.

In block 748, the device waits until its turn to transmit the RRA response. This may involve, for example, determining one or more backoff values and waiting for the determined value before initiating transmission of the RRA response. As discussed in more detail above, the one or more backoff values may be determined based on the position of the one of more matching addresses identified in block 705 within the RRM, or based on the relative values of the AP addresses (e.g. AID or MAC) corresponding to the one or more devices identified in the RRM. Once the device determines that it is allowed to transmit the RRA response, it proceeds to block 750.

In block 750, the device identifies the RRA type value that was determined earlier in block 730a, b, or c, and proceeds to blocks 755a, b, or c to send the RRA message according to the RRA type value, “accept”, “reject”, and “accept with modifications”, respectively. The device may include in the RRA one or more addresses included in the RRM, such as its own address and one or more of its associated STAs. The device may include one or more parameters in the RRA according to the RRA type. For example, if the RRA type is “accept”, the device may insert the same values in the Duration and (optionally) Period values as included in the RRM. By further example, if the RRA type is “reject”, the device may insert zero-valued Duration and (optionally) Period fields. By further example, if the RRA type is “accept with modifications”, the device may include one or more of the Duration, Period, and Offset fields comprising previously determined values.

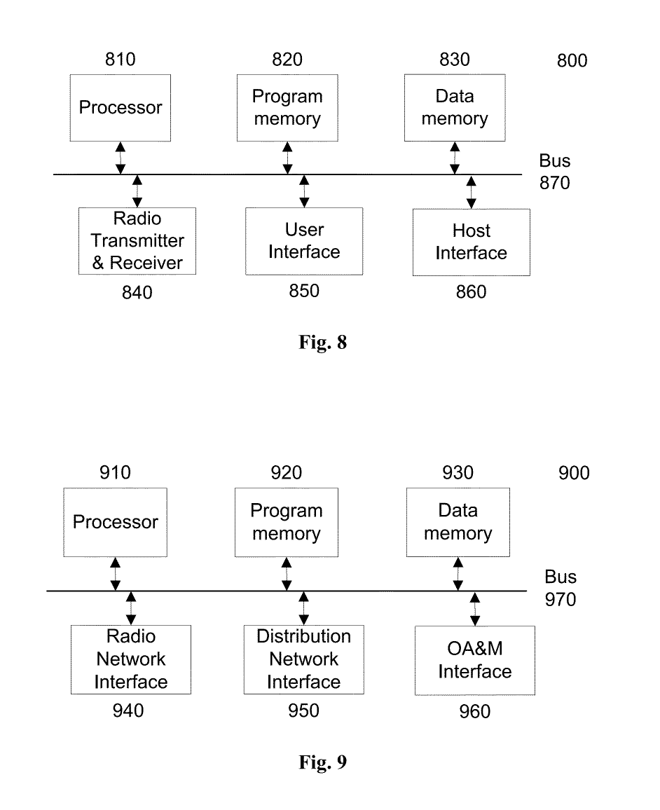

FIG. 8 is a block diagram of exemplary wireless communication device or apparatus, such as an 802.11 STA, utilising certain embodiments of the present disclosure, including one or more of the methods described above with reference to other figures. Device 800 comprises processor 810 which is operably connected to program memory 820 and data memory 830 via bus 870, which may comprise parallel address and data buses, serial ports, or other methods and/or structures known to those of ordinary skill in the art. Program memory 820 comprises software code executed by processor 810 that enables device 800 to communicate with one or more other devices using protocols according to various embodiments of the present disclosure, including the 802.11 PHY and MAC protocol layer and improvements thereto, including those described above with reference to other figures. In some embodiments, program memory 820 may also comprise software code executed by processor 810 that enables device 800 to communicate with one or more other devices using protocols other than 802.11, such as LTE, UMTS, HSPA, GSM, GPRS, and EDGE protocols standardised by 3GPP; CDMA2000 protocols standardised by 3GPP2; Internet protocols such as IP, TCP, UDP, or others known to persons of ordinary skill in the art; or any other protocols utilised in conjunction with radio transceiver 840, user interface 850, and/or host interface 860. Program memory 820 further comprises software code executed by processor 810 to control the functions of device 800, including configuring and controlling various components such as radio transceiver 840, user interface 850, and/or host interface 860. Such software code may be specified or written using any known or future developed programming language, such as e.g. Java, C++, C, and Assembler, as long as the desired functionality, e.g. as defined by the implemented method steps, is preserved.

Data memory 830 may comprise memory area for processor 810 to store variables used in protocols, configuration, control, and other functions of device 800. As such, program memory 820 and data memory 830 may comprise non-volatile memory (e.g. flash memory), volatile memory (e.g. static or dynamic RAM), or a combination thereof. Persons of ordinary skill in the art will recognise that processor 810 may comprise multiple individual processors (not shown), each of which implements a portion of the functionality described above. In such a case, multiple individual processors may be commonly connected to program memory 820 and data memory 830 or individually connected to multiple individual program memories and or data memories. More generally, persons of ordinary skill in the art will recognise that various protocols and other functions of device 800 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio transceiver 840 may comprise radio-frequency transmitter and/or receiver functionality that enables device 800 to communicate with other equipment supporting like wireless communication standards. In an exemplary embodiment, radio transceiver 940 includes a transmitter and receiver compatible with the 802.11 standard that enable device 800 to communicate with various other devices according to the 802.11 standard. In some embodiments, radio transceiver 840 includes circuitry, firmware, etc. necessary for device 800 to communicate with other devices, such as 802.11 STAs and APs, using the PHY protocol layer methods and improvements thereto such as those described above with reference to other figures. In some embodiments, radio transceiver 840 is capable of communicating on one or more unlicensed frequency bands including, for example, frequency bands in the regions of 900 MHz, 2.4 GHz, 3.6 GHz, and 5 GHz. The person of ordinary skill will understand that other bands, licensed or unlicensed, may be supported in radio transceiver 840 by adding appropriate circuitry. The radio functionality particular to each of these embodiments may be coupled with or controlled by other circuitry in device 800, such as processor 810 executing protocol program code stored in program memory 820.

User interface 850 may take various forms depending on the particular embodiment of device 800. In some embodiments, device 800 is a mobile phone, in which case user interface 850 may comprise a microphone, a loudspeaker, slidable buttons, depressible buttons, a keypad, a keyboard, a display, a touchscreen display, and/or any other user-interface features commonly found on mobile phones. In other embodiments, device 800 is a data modem capable of being utilised with a host computing device, such as a data card or data modem contained within a host computing device, such as a laptop computer or tablet. In some embodiments, device 800 is capable of being plugged into a USB port of the host computing device. In embodiments such as these, user interface 850 may be very simple or may utilise features of the host computing device, such as the host's display and/or keyboard.

Host interface 860 of device 800 also may take various forms depending on the particular embodiment of device 800. In embodiments where device 800 is a mobile phone, host interface 860 may comprise a USB interface, an HDMI interface, or the like. In the embodiments where device 800 is a data modem capable of being utilised with a host computing device, host interface may be a USB or PCMCIA interface.

In some embodiments, device 800 may comprise more functionality than is shown in FIG. 8. In some embodiments, device 800 may also comprise functionality such as a video and/or still-image camera, media player, etc., and radio transceiver 840 may include circuitry necessary to communicate using radio-frequency communication standards other than 802.11, including GSM, GPRS, EDGE, UMTS, HSPA, CDMA2000, LTE, Bluetooth, GPS, and/or others. Persons of ordinary skill in the art will recognise the above list of features and radio-frequency communication standards is merely exemplary and not limiting to the scope of the present disclosure. Accordingly, processor 810 may execute software code stored in program memory 820 to control such additional functionality.

FIG. 9 is a block diagram of an exemplary wireless communication device 900, such as an 802.11 AP, utilising certain embodiments of the present disclosure, including those described above with reference to other figures. Device 900 comprises processor 910 which is operably connected to program memory 920 and data memory 930 via bus 970, which may comprise parallel address and data buses, serial ports, or other methods and/or structures known to those of ordinary skill in the art. Program memory 920 comprises software code executed by processor 910 that enables device 900 to communicate with one or more other devices using protocols according to various embodiments of the present disclosure, such as the 802.11 PHY and MAC protocol layer and improvements thereto, including those described above with reference to other figures. Program memory 920 also comprises software code executed by processor 910 that enables device 900 to communicate with one or more other devices using other protocols or protocol layers, including any other higher-layer protocols utilised in conjunction with radio network interface 940 and distribution network interface 950. By way of example and without limitation, distribution network interface 950 may comprise an IEEE 802.3 wired LAN (“Ethernet”) interface that is commonly known to persons of ordinary skill in the art. Program memory 920 further comprises software code executed by processor 910 to control the functions of device 900, including configuring and controlling various components such as radio network interface 940, distribution network interface 950, and OA&M interface 960.

Data memory 930 may comprise memory area for processor 910 to store variables used in protocols, configuration, control, and other functions of device 900. Data memory 930 may be used to store databases and other information used in one or more of the embodiments described herein, such as an overlapping BSS (OBSS) interference database. As such, program memory 920 and data memory 930 may comprise non-volatile memory (e.g. flash memory, hard disk, etc.), volatile memory (e.g. static or dynamic RAM), network-based (e.g. “cloud”) storage, or a combination thereof. Persons of ordinary skill in the art will recognise that processor 910 may comprise multiple individual processors (not shown), each of which implements a portion of the functionality described above. In such a case, multiple individual processors may be commonly connected to program memory 920 and data memory 930 or individually connected to multiple individual program memories and/or data memories. More generally, persons of ordinary skill in the art will recognise that various protocols and other functions of device 900 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio network interface 940 may comprise transmitters, receivers, signal processors, ASICs, antennas, beamforming units, and other circuitry that enables device 900 to communicate with other equipment such as, in some embodiments, a plurality of compatible STAs. In some embodiments, radio network interface may comprise various protocols or protocol layers, such as the 802.11 PHY and MAC layer protocols standardised by IEEE, improvements thereto such as described herein with reference to one of more of the figures, or any other higher-layer protocols utilised in conjunction with radio network interface 940. In some embodiments, the radio network interface 940 may comprise a PHY layer based on orthogonal frequency division multiplexing (OFDM) or orthogonal frequency division multiple access (OFDMA) technologies.

Distribution network interface 950 may comprise transmitters, receivers, and other circuitry that enables device 900 to communicate with other equipment in a distribution network such as, in some embodiments, a wired network based on the IEEE 802.3 wired LAN standard. OA&M interface 960 may comprise transmitters, receivers, and other circuitry that enables device 900 to communicate with external networks, computers, databases, and the like for purposes of operations, administration, and maintenance of device 900 or other network equipment operably connected thereto. Lower layers of OA&M interface 960 may be compatible with one or more of the IEEE 802.3 wired LAN and IEEE 802.11 wireless LAN standards. In some embodiments, one or more of radio network interface 940, distribution network interface 950, and OA&M interface 960 may be multiplexed together on a single physical interface, such as the examples listed above.

As described herein, a device or apparatus may be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. A device or apparatus may be regarded as a device or apparatus, or as an assembly of multiple devices and/or apparatus, whether functionally in cooperation with or independently of each other. Moreover, devices and apparatus may be implemented in a distributed fashion throughout a system, so long as the functionality of the device or apparatus is preserved. Such and similar principles are considered as known to a skilled person.

In an exemplary embodiment of the first exemplary embodiment, the apparatus may be arranged to:

receive interference reports from one or more devices in communication with the wireless communication device; and

create an interference database based on the received interference reports, wherein the existence of an interference condition and the set of interfering devices are determined based on the interference database.

In an exemplary embodiment of the first exemplary embodiment, the wireless communication device is an 802.11 access point (AP) and the one or more devices in communication with the wireless communication device are one or more 802.11 stations (STAs).

In an exemplary embodiment of the first exemplary embodiment, the set of devices is determined based on at least one of a minimum interference threshold and a maximum set size.

In an exemplary embodiment of the first exemplary embodiment, the information identifying at least one of the determined set of devices comprises an address corresponding to an 802.11 AP.

In an exemplary embodiment of the first exemplary embodiment, the information identifying at least one of the determined set of devices comprises at least one address corresponding to an 802.11 STA.

In an exemplary embodiment of the first exemplary embodiment, the information identifying at least one of the determined set of devices comprises an address corresponding to a plurality of 802.11 STAs.

In an exemplary embodiment of the first exemplary embodiment, the information identifying at least one of the determined set of devices comprises a broadcast address.

In an exemplary embodiment of the first exemplary embodiment, the first parameter identifies a duration of the requested reservation.

In an exemplary embodiment of the first exemplary embodiment, the reservation request comprises a parameter identifying a period of the requested reservation.

In an exemplary embodiment of the first exemplary embodiment, the apparatus may be arranged to schedule data communication to occur for the duration in each of a plurality of subsequent time intervals corresponding to the period.

In an exemplary embodiment of the first exemplary embodiment, the second parameter identifies a second duration; the wireless communication device being arranged to schedule data communication to occur for the second duration.

In an exemplary embodiment of the first exemplary embodiment, the second parameter identifies an offset from the current time; the wireless communication device being arranged to schedule data communication to begin at the offset from the current time and to continue for the duration.

In an exemplary embodiment of the first exemplary embodiment, the second parameter identifies a second duration; and the acknowledgement comprises a third parameter identifying a second period; the wireless communication device being arranged to schedule data communication to occur for the second duration in each of a plurality of subsequent time intervals corresponding to the second period.

In an exemplary embodiment of the first exemplary embodiment, the reservation request comprises a parameter identifying the directionality of the requested reservation.

In an exemplary embodiment of the first exemplary embodiment, the apparatus is arranged to schedule data communication via the shared medium if the interference condition is determined not to exist.

In an exemplary embodiment of the second exemplary embodiment, the at least one address related to the wireless communication device is at least one of an address of the wireless communication device and an address of a device associated with the wireless communication device.

In an exemplary embodiment of the second exemplary embodiment, the apparatus may be arranged to schedule data communication for devices associated with the wireless communication device but not identified by information in the reservation request.

In an exemplary embodiment of the second exemplary embodiment:

the data communication comprises uplink data traffic;

the wireless communication device being arranged to schedule data communication prior to sending the acknowledgement.

In an exemplary embodiment of the second exemplary embodiment, the first parameter identifies a duration of the requested reservation.

In an exemplary embodiment of the second exemplary embodiment, the reservation request comprises a parameter identifying a period of the requested reservation.

In an exemplary embodiment of the second exemplary embodiment, the second parameter identifies a second duration that is substantially the same as the duration of the requested reservation.

In an exemplary embodiment of the second exemplary embodiment, the second parameter identifies a second duration that is different from the duration of the requested reservation.

In an exemplary embodiment of the second exemplary embodiment, the acknowledgement comprises a parameter identifying a second period that is different from the period of the requested reservation.

In an exemplary embodiment of the second exemplary embodiment, the second parameter identifies an offset from the current time.

In an exemplary embodiment of the second exemplary embodiment, the acknowledgement type identifier is one of an accept, an accept with modification, and a reject.

In an exemplary embodiment of the second exemplary embodiment, the reservation request comprises a parameter identifying a directionality of the requested reservation.

In an exemplary embodiment of the second exemplary embodiment, the wireless communication device is an 802.11 access point (AP) and the device associated with the wireless communication device is an 802.11 station (STA).

In an exemplary embodiment of the second exemplary embodiment, the at least one address related to the wireless communication device is an address of a single 802.11 STA.

In an exemplary embodiment of the second exemplary embodiment, the at least one address related to the wireless communication device is an address corresponding to a plurality of 802.11 STAs.

In an exemplary embodiment of the second exemplary embodiment, the at least one address related to the wireless communication device is an 802.11 broadcast address.

In an exemplary embodiment of the third exemplary embodiment, the existence of the interference condition is determined based on identifiers that are present in the first set but absent from the second set.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. Apparatus for a wireless communication device, the apparatus comprising:
at least one processor;
and at least one memory including computer program code;
the at least one memory and the computer program code being configured to, with the at least one processor, cause the wireless communication device to:
determine the existence of an interference condition in an overlapping service area;
determine a set of devices related to the interference condition;
send a request to reserve the shared medium in the overlapping service area, wherein the reservation request comprises information identifying at least one of the determined set of devices and a first parameter characterising the requested reservation;
receive an acknowledgement from at least one of the devices identified in the reservation request, the acknowledgement comprising an acknowledgement type identifier and a second parameter characterising the requested reservation; and
schedule data communication via the shared medium based on the acknowledgement type identifier and at least one of the first parameter and the second parameter.

2. Apparatus according to claim 1, arranged to:
receive interference reports from one or more devices in communication with the wireless communication device; and
create an interference database based on the received interference reports, wherein the existence of an interference condition and the set of interfering devices are determined based on the interference database.

3. Apparatus according to claim 1, wherein the wireless communication device is an 802.11 access point (AP) and the one or more devices in communication with the wireless communication device are one or more 802.11 stations (STAs).

4. Apparatus according to claim 1, wherein the set of devices is determined based on at least one of a minimum interference threshold and a maximum set size.

5. Apparatus according to claim 1, wherein the information identifying at least one of the determined set of devices comprises an address corresponding to at least one of: an 802.11 AP; at least one address corresponding to an 802.11 STA; an address corresponding to a plurality of 802.11 STAs; and a broadcast address.

6. Apparatus according to claim 1, wherein the first parameter identifies a duration of the requested reservation.

7. Apparatus according to claim 6, wherein the reservation request comprises a parameter identifying a period of the requested reservation, and arranged to schedule data communication to occur for the duration in each of a plurality of subsequent time intervals corresponding to the period.

8. Apparatus according to claim 6, wherein:
the second parameter identifies a second duration;
the wireless communication device being arranged to schedule data communication to occur for the second duration.

9. Apparatus according to claim 6, wherein:
the second parameter identifies an offset from the current time;
the wireless communication device being arranged to schedule data communication to begin at the offset from the current time and to continue for the duration.

10. Apparatus according to claim 1, wherein:
the first parameter identifies a duration of the requested reservation;
the reservation request comprises a parameter identifying a period of the requested reservation;
the second parameter identifies a second duration; and
the acknowledgement comprises a third parameter identifying a second period;
the wireless communication device being arranged to schedule data communication to occur for the second duration in each of a plurality of subsequent time intervals corresponding to the second period.

11. Apparatus for a wireless communication device, the apparatus comprising:
at least one processor;
and at least one memory including computer program code;
the at least one memory and the computer program code being configured to, with the at least one processor, cause the wireless communication device to:
receive a request to reserve a shared medium in an overlapping service area, wherein the reservation request comprises information identifying at least one address related to the wireless communication device and a first parameter characterising the requested reservation;
determine an acknowledgement type identifier based on at least the first parameter;
schedule data communication via the shared medium based on the information identifying at least one address related to the wireless communication device; and
send an acknowledgement of the reservation request comprising the acknowledgement type identifier and a second parameter characterising the requested reservation.

12. Apparatus according to claim 11, wherein the at least one address related to the wireless communication device is at least one of an address of the wireless communication device and an address of a device associated with the wireless communication device.

13. Apparatus according to claim 11, arranged to schedule data communication for devices associated with the wireless communication device but not identified by information in the reservation request.

14. Apparatus according to claim 13, wherein:
the data communication comprises uplink data traffic;
the wireless communication device being arranged to schedule data communication prior to sending the acknowledgement.

15. Apparatus according to claim 11, wherein the first parameter identifies a duration of the requested reservation.

16. Apparatus according to claim 15, wherein the reservation request comprises a parameter identifying a period of the requested reservation.

17. Apparatus according to claim 15, wherein the second parameter identifies an offset from the current time.

18. Apparatus according to claim 11, wherein the wireless communication device is an 802.11 access point (AP) and the device associated with the wireless communication device is an 802.11 station (STA).

19. Apparatus according to claim 18, wherein the at least one address related to the wireless communication device is at least one of: an address of a single 802.11 STA; an address corresponding to a plurality of 802.11 STAs; and an 802.11 broadcast address.

20. A method for determining the existence of an interference condition in an overlapping service area of a plurality of wireless networks, the method comprising:
receiving one or more signals transmitted by access points in a shared medium of the overlapping service area;
determining a first set of identifiers of wireless networks in the overlapping service area based on information comprising the one or more signals transmitted by the access points;
receiving one or more signals transmitted by stations in the shared medium;
determining a second set of identifiers of wireless networks in the overlapping service area based on information comprising the one or more signals transmitted by the stations; and
determining the existence of the interference condition by comparing the first and second sets of identifiers.
